(19) United States
(12) Patent Application Publication
(10) Pub. No.: US 2005/0171920 A1
(43) Pub. Date: Aug. 4, 2005

(54) Mailing machine having translucent covers

(76) Inventors: Rana Dutta, Easton, CT (US); Dana Foster, Torrington, CT (US)

Correspondence Address: PERMAN & GREEN, 425 POST ROAD, FAIRFIELD, CT, 06824, US

(21) Appl. No.: 10/768,759

(22) Filed: Jan. 30, 2004

(51) Int. Cl. G06F 17/60

(52) U.S. Cl. 705/406; 705/401

(57) ABSTRACT

A mailing machine for franking mail items. The mailing machine has a franking device having a franking head and a mail feeder. The mail feeder is adapted to feed the mail items to the franking head. A user interface has a display and a keypad. Circuitry is adapted to interface with the user interface. A first cover encloses a portion of the mailing machine. The first cover has a viewing area being transparent or semi-transparent. A user may view an interior portion of the mailing machine other than the display or in addition to the display through the viewing area of the first cover.

### BACKGROUND

1. Field of the Invention

The present invention relates to a mailing machine and, more particularly, to an enclosure for a mailing machine.

2. Description of Earlier Related Developments

Mailing machines enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples. A problem arises when a user would like to view the interior of the mailing machine, such as where there is a jam or where the user would like to observe operation of mechanisms which normally be obstructed by housings or covers. Another problem arises when a user would like to change the outward appearance of the mailing machine, such as in the case where the user would like it to stand out from other office equipment or to match other office equipment or to personalize the mailing machine. Accordingly, there is a desire to provide a mailing machine where the user can easily view an interior portion which is easily personalized and can easily be configured.

### SUMMARY OF THE EMBODIMENTS

In accordance with one exemplary embodiment, a mailing machine for franking mail items is provided. The mailing machine has a franking device having a franking head. A user interface is provided having a display and a keypad. Circuitry is provided and adapted to interface with the user interface. A first cover is provided enclosing a portion of the mailing machine, the first cover having a viewing area being transparent or semi-transparent. A user may view an interior portion of the mailing machine other than the display or in addition to the display through the viewing area of the first cover.

In accordance with another exemplary embodiment, a mailing machine for franking mail items is provided. The mailing machine has a franking device having a franking head and a mail feeder being adapted to feed the mail items to the franking head. A user interface is provided having a display and a keypad. Circuitry is provided and adapted to interface with the user interface. A detachable first cover is enclosing at least a portion of the mailing machine. A detachable second cover is provided having, an appearance different than the detachable first cover. A user may remove the detachable first cover from the mailing machine and replace the detachable first cover with the detachable second cover.

In accordance with still another exemplary embodiment, a mailing machine for franking mail items is provided. The mailing machine has a franking device having a franking head. A user interface is provided having a display and a keypad. Circuitry is provided and adapted to interface with the user interface. A first cover is enclosing a portion of the mailing machine. A second overlay cover is provided covering a portion or all of the first cover.

The second overlay cover is removable and replaceable with a different third overlay cover.

### BRIEF DESCRIPTION OF THE DRAWINGS

The foregoing aspects and other features of the exemplary embodiments are explained in the following description, taken in connection with the accompanying drawings, wherein:

FIG. 1 is a schematic block diagram of a mailing machine incorporating features in accordance with an exemplary embodiment;

FIG. 2 is an isometric view of the mailing machine in FIG. 1; and

FIG. 3 is an isometric view of a mailing machine in accordance with another exemplary embodiment.

### DETAILED DESCRIPTION OF THE EXEMPLARY EMBODIMENT(S)

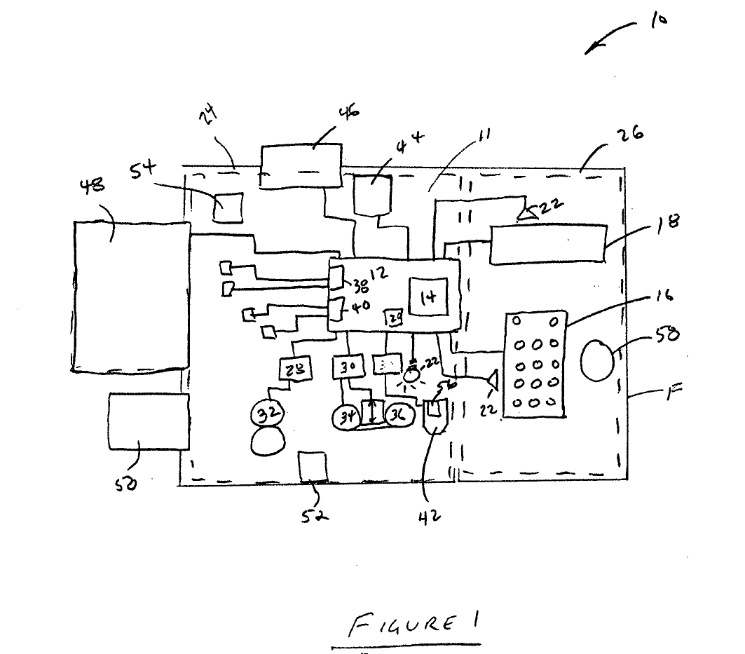

Referring to FIG. 1, there is shown, a schematic block diagram of a mailing machine 10 incorporating features in accordance with one exemplary embodiment of the present invention. Although the present invention will be described with reference to the embodiments shown in the drawings, it should be understood that the present invention can be embodied in many alternate forms of embodiments. In addition, any suitable size, shape or type of elements or materials could be used.

Mailing machine 10, in the embodiment shown, generally comprises a franking device 11. The mailing machine 10 and its sections described in greater detail below is merely exemplary, and in alternate embodiments the mailing machine may have any other sections or systems. Mailing machine 10 is illustrated as a generic type of mailing machine, and may be any suitable type of mailing machine, such as a digital or analog mailing machine. Suitable examples of mailing machines, to which the features of the exemplary embodiments described herein are applicable, are the Neopost HASLER® PowerPost or WJ class of postage meters, or the Neopost HASLER® analog models of postage meters. However, as noted before, the features in accordance with the exemplary embodiments described herein are equally applicable to any other suitable type or make of mailing machine.

Mailing machine 10 generally has circuitry 12 which may have microprocessor 14 which effects operation of the franking machine. A user interface, such as a keyboard 16 may be provided to input data by a user. Display 18 may be provided to display status or other information as to the operation of mailing machine 10. Memory 20 may be provided to store data. Lamp or illumination device(s) 22 may be provided to illuminate the interior of the mailing device 10, covers 24, 26 of mailing device 10 or other suitable items such as the keypad or display. Motor controller(s) 28, 30 may be provided for driving items such as feeder 32 or marking means such as ink ribbon 34, impression roller and raise/lower drive 36. In alternate embodiments, the mailing machine may have any other suitable marking means such as an ink jet head or laser printing head. Inputs 38 and outputs 40 may be provided to interface to sensors or other devices, such as optical detectors, indicators, actuators or otherwise. Print element 42 may be provided to print mail indicia on mail items as they are fed or as an alternate to an impression roller. Additional peripheral devices, such as modem 44, scale 46, folder 48, insertion device 50, moistener/sealer 52, label dispenser 54, ink cartridge 56, speaker device 58, or other peripheral devices may be provided. FIG. 1 shows that one or more of the sections of the mailing machine 10 is mounted or held on a frame F. The frame F is shown schematically in FIG. 1, and may comprise a number of frame portions that may be connected or independent of each other. As noted before, the machine 10 shown in FIG. 1 and described above is merely exemplary and not meant to be the exclusive embodiment. In alternate embodiments, more or less features may be provided, such as where more, less or different components are provided within cover(s) 24, 26 or where there is a single cover for example. Further, for example, a wireless or computer interface could be provided, or a battery may be disposed within mailing machine 10. As yet a further example, a custom message interface could be provided or docking interfaces, power interface, status indicators, other connections, labels, network connections, additional user interfaces, or otherwise may be provided.

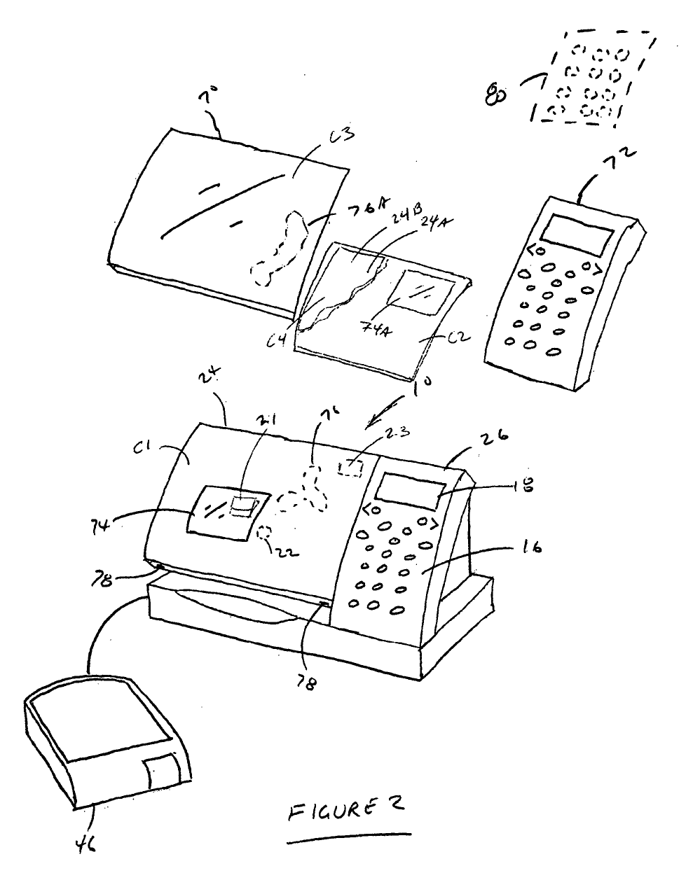

Referring also to FIG. 2, mailing machine 10 is shown with covers 24, 26. Covers 24, 26 may be a molded polymer plastic shell or may alternately be made as or from a composite material(s), from metal or other suitable material or method. Cover 24 may be removable from mailing machine 10 and replaceable with a cover 70, 24A as an example. Covers 24, 24A, and 70 are interchangeable and each has a different characteristic as will be described (only three covers are shown for example purposes though in alternate embodiments any suitable number of interchangeable covers may be provided). Any of the covers 24, 24A, and 70 may be selected as desired for mounting on the machine 10. This allows the user to easily change the covers in order to change the color, appearance, features, applications or other characteristics of the mailing machine 10. Covers 24, 26, 70, and 72 are shown as being exemplary. Cover 24 is shown enclosing or covering a portion of the mailing machine. In alternate embodiments, cover 24 could cover all, more or less of the mailing machine 10. Cover 24 may have a viewing area 74 being transparent or semi-transparent. In alternate embodiments, more or less viewing areas of different shapes may be provided in cover 24 or other covers or overlays. In alternate embodiments, cover 24 may have a larger or smaller viewing area or be entirely transparent or semi-transparent or be entirely opaque. The enclosure, cover or housing may cover a portion or all of mailing machine 10. One or more of the covers 24A, 70 may be translucent or semi-transparent, allowing a user to at least partially view the interior portions 21, 23 of one or more sections of the machine. One or more of the covers may have the viewing area 74A located in another area of the cover. One or more of the covers may also have a color while still maintaining the translucent or semi-transparent characteristics, allowing a user to at least partially view at least a portion of the interior of the mailing machine through the colored, semi-transparent or translucent cover. In alternate embodiments to covers, overlays or combinations of covers and overlays could be provided. As seen in FIG. 2, when cover 24 is mounted, a user may view one or multiple interior portion(s) 21 of the mailing machine 10, such as for example portions of circuitry 12 or a mail feeder 32 or print head(s) through viewing area 74. In alternate embodiments, other portion(s) in whole or in part may be viewed. When covers 24A, or 70 are selected and mounted to the machine, the corresponding viewing areas may be disposed to make other interior portions 23 of the machine visible through the viewing area 24A. Cover 24 may be colored with a single color or multiple colors Cl and may be partially opaque or solid colored. Examples of such colors may be blue, gold beige or other color(s). Cover 24 may have pattern 76 comprising more than one color or shape. Interchangeable covers 24A, 70 may have different corresponding colors C2, C3 and patterns 76, 76A. The patterns and colors on the covers may represent varied data such as identification data of the machine or section of the machine. Cover 26 may be provided with the same or different color(s) or pattern(s) or with features similar or different to cover 24, such as for viewing a different portion of the interior of mailing machine 10. Illumination source(s) 22 may illuminate one or more interior portion(s) of the mailing machine 10 or may illuminate cover 24 or otherwise separately or in addition to the interior portion. The viewing area 74, 74A may also be sized to allow sufficient ambient light to make the interior portions 21, 23 of the machine visible without an interior source of illumination.

As noted before, cover 24, in addition to enclosing at least a portion of the mailing machine may be detachable from mailing machine 10. A user may remove the detachable first cover 24 from the mailing machine and replace the detachable first cover 24 with another of the detachable interchangeable covers 24A, 70 in order to change appearance, such as color, or in order to change other features, such as viewable area(s) or such as going from a transparent to solid colored cover. The covers 24, 24A, 70 may have viewing area(s) that are transparent or semi-transparent, or the cover may be entirely transparent or semitransparent allowing a user to view any desired interior portion(s) of the mailing machine other than the display or in addition to the display through the viewing area. Similarly, illumination source 22 may illuminate either the interior portion of the mailing machine 10 or the detachable first or second cover 24, 70. Fasteners 78 may be provided to couple the cover(s) to the mailing machine. Fasteners 78 may have similar or different color(s) that the cover(s). In alternate embodiments, more or less cover(s) having different characteristics could be provided. As an alternate to a replaceable cover, an overlay cover 72 may be provided that may cover a portion, all or more than a cover, such as cover 26. Further, one or more of the covers 24A may be provided with a removable insert or applique 24B that allows the cover color or indicia pattern 76, 76A to be changed as described. The overlay cover 72 may be removable and replaceable with a different overlay cover 80 which may have the same or different characteristics. Overlay cover 72 or 80 may be solid colored, or may be transparent or semi-transparent. Cover 26, 72, 80 may have viewing area(s) being transparent or semi-transparent where a user may view an interior portion of the mailing machine other than the display or in addition to the display through the viewing area. The keys of keypad 16 may extend through both the cover 26 and either of the overlays 72, 80. In alternate embodiments, overlays 72, 80 would cover the keys and may allow the user to still punch the keys. Overlay 72, 80 may be provided such that a user can discard them when they need cleaning or change them when a different appearance is desired. Overlay covers 72, 80 may have the same or different colors. In alternate embodiments, more or less covers with different characteristics could be provided.

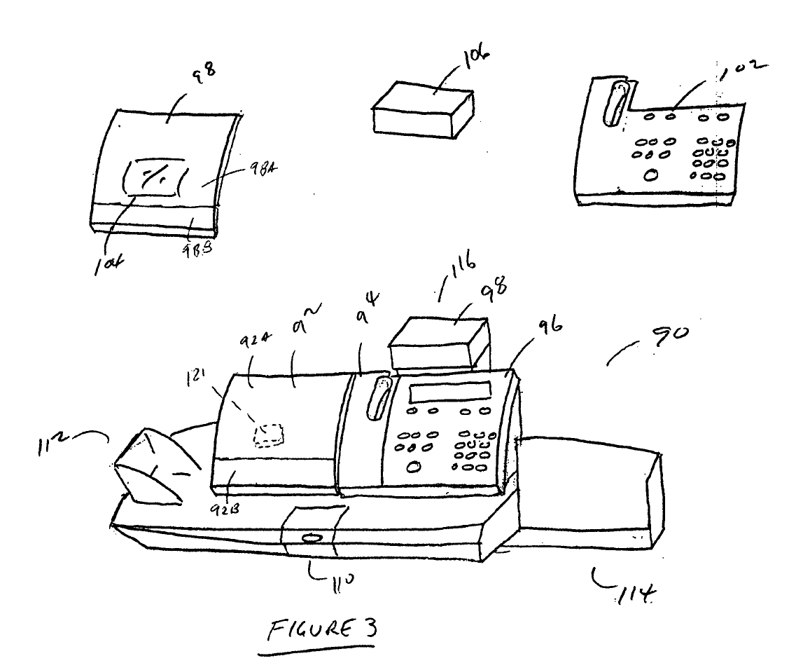

Referring also to FIG. 3 there is shown another mailing machine 90 with covers 92, 94, 96 and 98 in accordance with another exemplary embodiment. Mailing machine. 90 has seal metering device 110, mail staging area 112 and metered mail area 114. Cover 92 may be removable from mailing machine 10 and replaceable with a cover 98 from a number of different interchangeable covers (only one cover 98 is shown for example). In FIG. 3, only cover 92 is shown as being interchangeable, for example. Covers 94, 96, 98 may also be interchangeable from a number of different covers (not shown). This allows the user to easily change the covers in order to change the color, appearance, features, applications or other characteristics of the mailing machine 90. Cover 98 may have a viewing area 104 being transparent or semi-transparent. In alternate embodiments, cover 98 may be a colored semi-transparent overlay and cover 92 may have a viewing area or be entirely transparent or semi-transparent or be entirely opaque or may employ other alternative combinations contemplated. As described before with respect to mailing machine 10, a user may view one or multiple interior portion(s) 121 of the mailing machine, such as for example circuitry or a mail feeder or print head(s) through viewing area 104. In alternate embodiments, other portion(s) in whole or in part may be viewed by selecting covers with suitably located viewing areas. Covers may be colored with a single color or multiple colors and may be partially opaque or solid colored. Examples of such colors may be blue, gold beige or other color(s). As examples of alternates, metering station 116 may use overlay 106. As a further alternate, covers 96 and 94 may use overlay 102 to partially overlay cover 96 and 94. Alternately, cover 98 may be removable and replaceable with cover 106. Illumination source(s) may be provided to illuminate one or more interior portion(s) of the mailing machine 90 or may illuminate covers or overlays. Covers and overlays may have appearance different from each other. Either the detachable covers or overlays may have viewing area(s) being transparent or semi-transparent or may be entirely transparent or semitransparent allowing a user to view an interior portion(s) of the mailing machine other than the display or in addition to the display through the viewing area. Fasteners may be provided to couple the cover(s) to the mailing machine having similar or different color(s) that the cover(s).

In this embodiment, one or more of the covers 92 may be modular, comprising one or more interconnected sections 92A, 92B. The cover sections 92A, 92B may be removably connectable to each other by any suitable means such as mechanical interlocks for example. One or more of the cover sections 92A, 92B may be individually interchangeable with corresponding interchangeable sections 98A, 98B of another cover 98. Thus, if it is desired to replace but a portion of the mounted cover, the portion 92A may be removed without removal of the entire cover and replaced with another interchangeable portion 98A. In alternate embodiments, more or less cover(s) having different characteristics could be provided, such as where a third cover could be provided with a separate viewing area being transparent or semi-transparent or with a different pattern or color or transparency, where the user may view a different interior portion of the mailing machine other than the display or in addition to the display through the separate viewing area. As an alternate to a replaceable cover, an overlay cover may be provided that may cover a portion, all or more than a cover, such as cover 98. Overlay covers 102 or cover 98, as examples, may be removable and replaceable with a different overlay cover or cover which may have the same or different characteristics. The keys of the keypad may similarly extend through both the cover 96 and overlay 102 or otherwise. In alternate embodiments, more or less covers with different characteristics could be provided. The description above is merely intended to be exemplary. More or less features could also be provided.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A mailing machine for franking mail items comprising:
a frame holding at least one section of the mailing machine, the at least one section being at least one of a franking section having a franking head, a feed station, or a circuitry section;
a user interface connected to the frame; and
a first cover connected to the frame and covering a portion of the at least one section, the first cover having a viewing area of transparent or semi-transparent material;
wherein, the viewing area is disposed for allowing viewing of an interior portion of the at least one section of the mailing machine.

2. The mailing machine for franking mail items of claim 1;
wherein the at least one section comprises the franking section and the feed section and wherein the interior portion includes an interior of the franking section and of the feed section viewable through the viewing area.

3. The mailing machine for franking mail items of claim 2 wherein the first cover has a first predetermined characteristics, the first cover being selectable from a number of different interchangeable covers each having different predetermined characteristics.

4. The mailing machine for franking mail items of claim 3 wherein the first predetermined characteristic is visible indicia.

5. The mailing machine for franking mail items of claim 1 further comprising a second cover, the second cover being opaque, and interchangeable with the first cover.

6. The mailing machine for franking mail items of claim 1 further comprising an illumination source, wherein the illumination source illuminates the interior portion.

7. The mailing machine for franking mail items of claim 1, wherein the viewing area is disposed to allow assembly illumination for viewing the interior portion.

8. A mailing machine for franking mail items comprising:
a franking device having a franking head and a mail feeder being adapted to feed the mail items to the franking head;
a user interface operably connected to the franking device;
circuitry interfacing the user interface to the franking device;
a detachable first cover for covering at least a portion of at least one of the franking device, feeder, or circuitry; and
a detachable second cover having an appearance different than the detachable first cover and being interchangeable with the first cover.

9. The mailing machine of claim 8 wherein at least one of the detachable first cover or the detachable second cover has a viewing area of transparent or semi-transparent material, the viewing area being disposed so that an interior portion of the at least one of the franking device, feeder, or circuitry is viewable through the viewing area.

10. The mailing machine of claim 8 further comprising an illumination source, wherein the illumination source illuminates at least one of the interior portion, the first cover or second cover.

11. The mailing machine of claim 8 further comprising fasteners adapted to couple the detachable first cover to the at least one of the franking device, feeder, or circuitry; wherein, the fasteners are a different color than the first cover.

12. The mailing machine of claim 9 further comprising a third cover, wherein the third cover has another viewing area of transparent or semi-transparent material, and wherein the other viewing area is disposed to allow viewing of a different interior portion of the mailing machine, other than a portion of the user interface, through the other viewing area.

13. The mailing machine of claim 12 wherein the third cover is at least partially opaque and having a color different than either the detachable first or second covers.

14. A mailing machine for franking mail items comprising:
a frame holding at least one operable section of the mailing machine, the at least one section being at least one of a franking section having a franking head, a feed section, or a circuitry section;
a user interface connected to the frame;
a first cover connected to the frame and covering a portion of the at least one section; and
an overlay cover, the overlay cover covering a portion or all of the first cover;
wherein, the overlay cover is removable and replaceable with a different overlay cover with a different predetermined characteristic than the overlay cover.

15. The mailing machine of claim 14 wherein, the overlay cover is transparent or semi-transparent.

16. The mailing machine of claim 15 wherein the first cover has a viewing area that is transparent or semi-transparent, wherein the viewing area is disposed so that an interior portion of the at least one section is visible through the viewing area of the first cover.

17. The mailing machine of claim 16 wherein at least a portion of the user interface extends through both the first cover and the overlay cover.

18. The mailing machine of claim 16 wherein the overlay cover has a different color than the different overlay cover.

19. The mailing machine of claim 14 further comprising a fourth cover, wherein the fourth cover has a viewing area that is transparent or semi-transparent, and wherein the viewing area is disposed so that an interior portion of the at least one section is visible through the viewing area.

20. The mailing machine of claim 16 further comprising a fourth cover, wherein the fourth cover has another viewing area that is transparent or semi-transparent, and wherein the other viewing area is disposed so that a different interior portion of the at least one section is visible through the other viewing area.
